(19) United States
(12) Patent Application Publication
(10) Pub. No.: US 2014/0032117 A1
(43) Pub. Date: Jan. 30, 2014

(54) SP Curve Drift Correction

(71) Applicant: Adrian Esteban Scillato, Chubut (AR)

(72) Inventor: Adrian Esteban Scillato, Chubut (AR)

(73) Assignee: BAKER HUGHES INCORPORATED, Houston, TX (US)

(21) Appl. No.: 13/559,233

(22) Filed: Jul. 26, 2012

(51) Int. Cl. G01V 3/38; G06F 19/00; G01V 3/18

(52) U.S. Cl. 702/7; 702/6; 702/87

(57) ABSTRACT

A method and apparatus for removing drift from a curve of raw data acquired from a wellbore that intersects a subterranean formation. The raw data curve is filtered to remove DC components, integrating the filtered curve generates a new baseline curve. Adding the new base line curve to the filtered curve yields a corrected curve that is used to extract drift from the raw data curve. The corrected curve is filtered and then subtracted from the raw data curve to produce a drift curve. A data curve, absent any drift, is generated by filtering the drift curve, and subtracting the filtered data curve from the raw data curve.

### BACKGROUND

1. Field of Invention

The present disclosure relates in general to a method and apparatus for processing data obtained from a subterranean formation. More specifically, the present disclosure relates to a method and apparatus for eliminating drift from a plot of discrete measurements taken along a wellbore that intersects the formation.

2. Description of Prior Art

Data collected from a wellbore is analyzed for characterizing the wellbore typically includes radar, seismic, acoustic, sonar, radio waves, and nuclear. Often the data received and recorded can include unwanted signals or noise, which intermingle with the desired data and distort the final recordings thereby providing skewed results. In addition to noise, raw recorded data can also include a drift that affects the baseline of the recorded data. Factors causing drift in data when being recorded with a wireline tool include a length of the wireline, changes in density of wellbore fluid, changes in salinity, varying temperature, and differences in resistivity encountered downhole.

### SUMMARY OF THE INVENTION

Provided herein is a method and apparatus for conditioning data obtained in a wellbore. In an example embodiment, a method of processing a curve of raw data acquired from a wellbore includes filtering the curve of raw data to create an intermediate curve, integrating the intermediate curve to create a new baseline curve, estimating a drift curve that represents drift in the curve of raw data and that is based on new baseline curve and the curve of raw data, and generating a data curve by subtracting the drift curve from the curve of raw data. Optionally, the step of subtracting the new baseline curve from the intermediate curve to generate a corrected curve of raw data further involves subtracting a finite from the corrected curve of raw data to account for a loss of gain during the step of filtering the curve of raw data. In an alternative, the method further includes subtracting the new baseline curve from the intermediate curve to generate a corrected curve of raw data. In this example the step of estimating a drift curve includes subtracting the corrected curve of raw data from the curve of raw data. The method may optionally further include filtering the corrected curve of raw data. The method may optionally further include filtering the drift curve. In an embodiment, the curve of raw data includes spontaneous potential measured with an electrode disposed in the wellbore. In this example the electrode is provided with a downhole tool in the wellbore that is deployed on a wireline. The step of filtering the curve of raw data to create an intermediate curve may include removing a zero frequency component from a Fourier transform of the curve of raw data.

Another example method of investigating a wellbore include providing a downhole tool having an electrode, deploying the downhole tool in the wellbore, collecting data by measuring potentials from within the wellbore with the electrode, generating a raw data curve from the step of collecting data, filtering a zero frequency component from the raw data curve to create an intermediate curve, integrating the intermediate curve to create a new baseline curve, subtracting the new baseline curve from the intermediate curve to generate a corrected curve of raw data, filtering the corrected curve of raw data to create a filtered corrected curve of raw data, generating a drift curve that represents a drift in the curve of raw data by subtracting the filtered corrected curve of raw data from the curve of raw data, and generating a data curve by subtracting the drift curve from the curve of raw data. In an example the zero frequency component is a coefficient of a Fourier transform of the raw data curve. Optionally, the step of filtering the corrected curve of raw data involves eliminating high frequency noise from the curve. The method may further include filtering the drift curve.

Also disclosed herein is a machine for processing a raw data curve that is made up of a processor positioned to process the raw data curve, an input/output interface for receiving and displaying data between the processor and a user, and a memory having stored therein computer program product, stored on a tangible computer memory media, operable on the processor. In this example the computer program product has a set of instructions that, when executed by the processor, cause the processor to process the raw data by performing the operations of, filtering the raw data curve to create an intermediate curve, integrating the intermediate curve to create a new baseline curve, creating a corrected data curve by comparing the intermediate curve and new baseline curve, comparing the raw data curve with the corrected data curve to estimate a drift curve that represents drift in the curve of raw data, and generating a data curve by subtracting the drift curve from the curve of raw data. In an example, the data curve is displayed on the output interface. The operations may be performed in a first computer process, and further operations may include filtering the corrected data curve and the drift curve. In an example, at least a portion of the processor is disposed in a downhole tool.

### BRIEF DESCRIPTION OF DRAWINGS

Some of the features and benefits of the present invention having been stated, others will become apparent as the description proceeds when taken in conjunction with the accompanying drawings, in which:

FIG. 1 is a side sectional view of an example of an imaging tool in a wellbore and a corresponding data plot in accordance with the present invention.

FIG. 2 is an example flowchart for processing data acquired in a wellbore in accordance with the present invention.

While the invention will be described in connection with the preferred embodiments, it will be understood that it is not intended to limit the invention to that embodiment. On the contrary, it is intended to cover all alternatives, modifications, and equivalents, as may be included within the spirit and scope of the invention as defined by the appended claims.

### DETAILED DESCRIPTION OF INVENTION

The method and system of the present disclosure will now be described more fully hereinafter with reference to the accompanying drawings in which embodiments are shown. The method and system of the present disclosure may be in many different forms and should not be construed as limited to the illustrated embodiments set forth herein; rather, these embodiments are provided so that this disclosure will be thorough and complete, and will fully convey its scope to those skilled in the art. Like numbers refer to like elements throughout.

It is to be further understood that the scope of the present disclosure is not limited to the exact details of construction, operation, exact materials, or embodiments shown and described, as modifications and equivalents will be apparent to one skilled in the art. In the drawings and specification, there have been disclosed illustrative embodiments and, although specific terms are employed, they are used in a generic and descriptive sense only and not for the purpose of limitation.

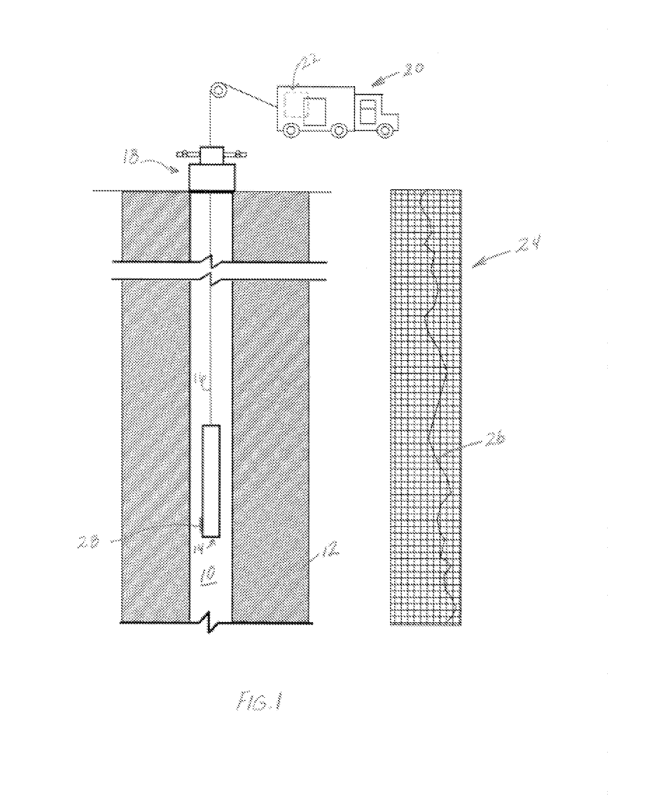

Illustrated in a side partial sectional view in FIG. 1 is one example embodiment of a wellbore 10 intersecting a formation 12. An example of a tool 14 is shown deployed in the wellbore 10 and suspended on a wireline 16, where the wireline 16 provides raising and lowering means as well as communication between the tool 14 and surface. The wireline 16 extends up the wellbore 10 and through a wellhead assembly 18 shown mounted at an opening of the wellbore 10 at surface. Optionally, a surface truck 20 may be provided on the surface and shown coupled to an upper end of the wireline 16, so that communication between the surface truck 20 and tool 14 may take place through the wireline 16. In one optional embodiment, an information handling system 22, shown in dashed outline, is provided in the surface truck 20. Schematically represented adjacent the formation 12 is an example graph 24 on which a curve 26 is plotted that represents raw data from the wellbore 10 recorded by the tool 14. An example of data includes a measurement of spontaneous potential between an electrode 28 on the tool 14 and a surface reference electrode (not shown), in which case curve 26 would be referred to as an SP curve. Another example of data includes a measurement of spontaneous potential from the tool electrode 28 and wireline 16, in which case curve 26 would be referred to as an SPDH curve. Yet another example of data includes spontaneous potential from a cable head electrode (not shown) versus the surface reference electrode, in which case curve 26 would be referred to as an SPCH curve. As is known, an amount of drift may be present within the curve 26 that offsets recorded values from actual values. As discussed above, factors affecting drift can be from the length of the wireline, properties of fluids in the wellbore, temperature, and properties of the formation 12.

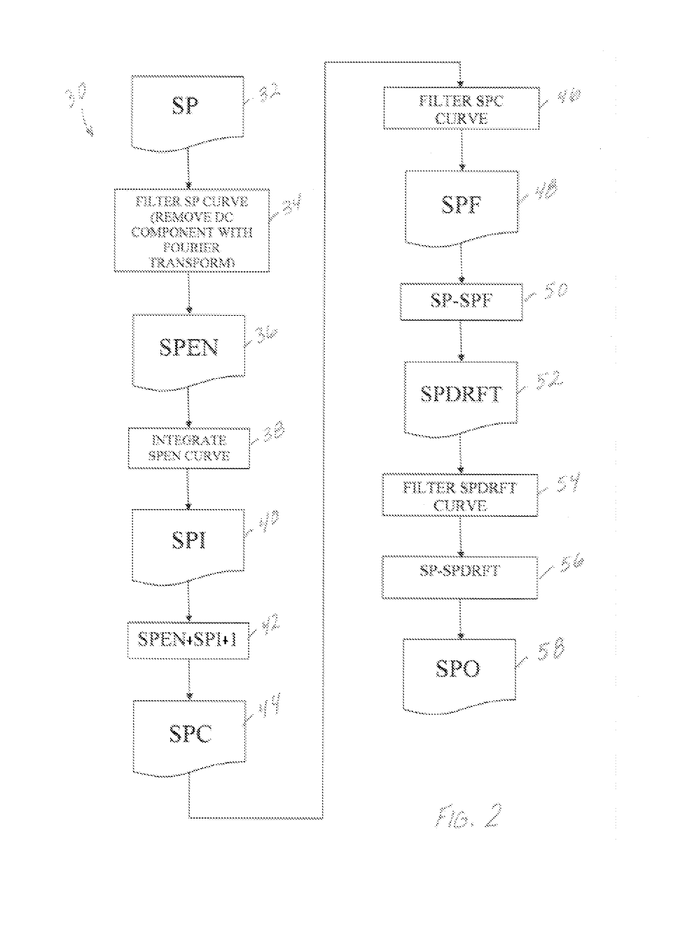

A flowchart 30 is provided in FIG. 2 that represents one example method for removing drift from raw recorded data. In step 32, SP data, such as that represented by curve 26 is provided. In an example, providing the data includes measuring characteristics of the wellbore with the tool 14. It should be pointed out that the data can be any of these spontaneous potential measurements as described above, or other downhole measurements. In one example, the SP curve 26 includes an AC component and a DC component, where the DC component includes baseline and drift. In an optional embodiment, an AC component describes a component whose value varies over time and may periodically be greater or less than a baseline value, whereas a DC component describes a component whose variances are not periodic. In step 34, the raw data from the SP curve is filtered so that the zero frequency component, or DC component, is removed from the raw data. In an example, filtering includes converting the raw data into the frequency domain from the time domain via a Fourier transform. When in the frequency domain, the zero frequency or DC component of the frequency plot is eliminated (e.g. the first coefficient of the Fourier transform), and the remaining data is retransformed into the time domain. As illustrated in step 36, filtering the raw data curve to remove the DC component generates a curve referred to as SPEN. By removing the DC components from the SP curve, the SPEN curve will not include noise from electrical power changes on an associated rig, but can contain information of how the SP curve varies. In an example, the step of removing the DC component from the raw data removes a baseline and drift from the raw data.

In step 38, a new baseline is generated by integrating the SPEN curve. In one example, a method of trapezoidal integration is performed on the SPEN curve to obtain an integrated value. The resulting curve from integrating the SPEN curve is the SPI curve shown in step 40 and optionally referred to herein as an intermediate curve. An advantage of integrating the SPEN curve is that the step of filtering results in primarily variations of the raw data curve. In an example, the SPEN curve is not a direct derivative of the SP curve, but may include variations of the SP curve and can be interpreted as an AC component. Thus in an exemplary embodiment, integrating the SPEN curve reconstructs the eliminated coefficient of the SPEN curve thereby obtaining a new DC component. The newly reconstructed DC component does not have a constant, or drift, from the original raw data, but can be interpreted as representing the baseline.

In step 42, an example of reconstructing the raw data curve of step 32 is shown wherein the SPI curve and the SPEN curve are summed. As noted above, the SPI curve can be interpreted as a DC component without drift and the SPEN curve can be interpreted as an AC component. Thus summing the SPEN curve and the SPI curve can yield a curve not having drift. Moreover, to account for loss of gain in the filter, a value of 1 is further added to this value. Depending on the filter employed, other values though can be implemented for accounting for the lost gain. In step 44, an SPC curve is formed by the process of step 42, where the SPC curve represents an SP curve, or raw data curve, without the drift in the values. Based on the SPC curve, the drift may be extracted from the original SP curve of step 32. More specifically, the SPC curve is filtered and in one example the filter involves using a low pass filter that eliminates high frequency noise of the curve. In the example of FIG. 2, an SPF curve, shown in step 48, results from filtering the SPC curve. Thus, a corrected SP curve (step 44) without noise is obtained in step 48.

In step 50, the SPF curve of step 48 is subtracted from the SP curve of step 32, and as shown in step 52, an SPDRFT curve is generated. In an example, the SPDRFT curve is a curve having or representing the value of drift of the raw data curve. The SPDRFT curve of step 52 is shown being filtered in step 54, in much the same fashion as the above described steps of filtering. The filtered drift curve SPDRFT then is subtracted from the raw data curve SP of step 32 to obtain SPO curve, of step 58. The SPO curve includes data from the SP curve of step 32, without the drift, but with information acquired during interrogation of the wellbore 10.

The present invention described herein, therefore, is well adapted to carry out the objects and attain the ends and advantages mentioned, as well as others inherent therein. While a presently preferred embodiment of the invention has been given for purposes of disclosure, numerous changes exist in the details of procedures for accomplishing the desired results. These and other similar modifications will readily suggest themselves to those skilled in the art, and are intended to be encompassed within the spirit of the present invention disclosed herein and the scope of the appended claims.

What is claimed is:

1. A method of processing a curve of raw data acquired from a wellbore comprising:
filtering the curve of raw data to create an intermediate curve;
integrating the intermediate curve to create a new baseline curve;
estimating a drift curve that represents drift in the curve of raw data and that is based on new baseline curve and the curve of raw data; and
generating a data curve by subtracting the drift curve from the curve of raw data.

2. The method of claim 1, wherein the step of subtracting the new baseline curve from the intermediate curve to generate a corrected curve of raw data further comprises adding a finite number from the corrected curve of raw data to account for a loss of gain during the step of filtering the curve of raw data.

3. The method of claim 1, further comprising summing the new baseline curve and the intermediate curve to generate a corrected curve of raw data.

4. The method of claim 3, wherein the step of estimating a drift curve comprises subtracting the corrected curve of raw data from the curve of raw data.

5. The method of claim 1, further comprising filtering the corrected curve of raw data.

6. The method of claim 1, further comprising filtering the drift curve.

7. The method of claim 1, wherein the curve of raw data comprises spontaneous potential measured with an electrode disposed in the wellbore.

8. The method of claim 5, wherein the electrode is provided with a downhole tool in the wellbore that is deployed on a wireline.

9. The method of claim 1, wherein the step of filtering the curve of raw data to create an intermediate curve comprises removing a zero frequency component from a Fourier transform of the curve of raw data.

10. A method of investigating a wellbore comprising:
providing a downhole tool having an electrode;
deploying the downhole tool in the wellbore;
collecting data by measuring potentials from within the wellbore with the electrode;
generating a raw data curve from the step of collecting data;
filtering a zero frequency component from the raw data curve to create an intermediate curve;
integrating the intermediate curve to create a new baseline curve;
summing the new baseline curve and the intermediate curve to generate a corrected curve of raw data;
filtering the corrected curve of raw data to create a filtered corrected curve of raw data;
generating a drift curve that represents a drift in the curve of raw data by subtracting the filtered corrected curve of raw data from the curve of raw data; and
generating a data curve by subtracting the drift curve from the curve of raw data.

11. The method of claim 10, wherein the zero frequency component is a coefficient of a Fourier transform of the raw data curve.

12. The method of claim 10, wherein the step of filtering the corrected curve of raw data comprises eliminating high frequency noise from the curve.

13. The method of claim 10, further comprising filtering the drift curve.

14. A machine for processing a raw data curve comprising:
a processor positioned to process the raw data curve;
an input/output interface for receiving and displaying data between the processor and a user; and
a memory having stored therein computer program product, stored on a tangible computer memory media, operable on the processor, the computer program product comprising a set of instructions that, when executed by the processor, cause the processor to process the raw data by performing the operations of:
a. filtering the raw data curve to create an intermediate curve;
b. integrating the intermediate curve to create a new baseline curve;
c. creating a corrected data curve by summing the intermediate curve and new baseline curve;
d. comparing the raw data curve with the corrected data curve to estimate a drift curve that represents drift in the curve of raw data; and
e. generating a data curve by subtracting the drift curve from the curve of raw data.

15. The machine of claim 14, wherein the data curve is displayed on the output interface.

16. The machine of claim 14, wherein operations (a)-(e) are performed in a first computer process, and further comprising: filtering the corrected data curve and the drift curve.

17. The machine of claim 14, wherein at least a portion of the processor is disposed in a downhole tool.
